(19) United States
(12) Patent Application Publication
(10) Pub. No.: US 2009/0196680 A1
(43) Pub. Date: Aug. 6, 2009

(54) Stretch type fixing mechanism

(75) Inventors: Tiger Hu, Shanhai City (CN); Tsai-Kuei Cheng, Taipei (TW)

Correspondence Address: Edwards Angell Palmer & Dodge LLP, P.O. Box 55874, Boston, MA, 02205, US

(73) Assignee: Inventec Corporation, Taipei City (TW)

(21) Appl. No.: 12/012,760

(22) Filed: Feb. 5, 2008

(51) Int. Cl. F16B 2/20; A47B 96/00

(52) U.S. Cl. 403/102; 312/223.2

(57) ABSTRACT

The present invention provides a stretch type fixing mechanism for an electronic device. The stretch type fixing mechanism includes a first component, a second component and a casing having a base plate to carry the first and the second components. The stretch type fixing mechanism includes a first limiting unit having a first wedging section disposed on the casing and a second wedging section disposed on the first component for limiting the first component to move relatively to the base plate in a first direction; a second limiting unit having a third wedging section disposed on the casing and a fourth wedging section disposed on the second component for limiting the second component to move relatively to the base plate in a second direction opposite to the first direction; and a positioning unit disposed on the first component and having a propping portion. By propping the propping portions against the blocking portions of the second component, the first and the second components are fixed to the casing without using screws.

### BACKGROUND OF THE INVENTION

1. Field of the Invention

The present invention generally relates to stretch type fixing mechanisms, and more particularly, to a stretch type fixing mechanism for components in and a casing of an electronic device.

2. Description of Related Art

As continuous development and advancing improvement in the electronic industry, designs of electronic products are all in a goal of achieving high performance and top quality. Therefore, among these, the electronic products capable of providing effectiveness such as easier application, promoting product quality and performance, facilitating assembling/disassembling and lowering production cost are creations with high applicability to the electronic industry.

Since the electronic industry is growing at a fast pace nowadays, performance of electronic devices such as computers and servers are also improved rapidly. The demand for larger memory sizes of the electronic devices continuously increases, and consequently a larger amount of hard disks and fans is demanded. Therefore, the casing on which the hard disk and fan are disposed demands a fixing mechanism with higher quality. For instance, in a server, a plurality of hard disks and fans are disposed on the casing to satisfy system needs, and the hard disks and the fans are fixed to the casing by screws.

Referring to FIG. 1, FIG. 1 is a schematic diagram showing a fan module and a hard disk module fixed in the casing of a server in the prior art. The casing 10 has a base plate 100 and two sidewalls 102, and is loaded with a fan module 11 and a hard disk module 12. The fan module 11 is adjacent to the hard disk module 12. The fan module 11, the hard disk module 12, the sidewalls 102 and the base plate 100 of the casing 1 have a plurality of holes 15, respectively. The fan module 11 and the hard disk module 12 are fixed in the casing 10 of the server by driving and fixing a screw 16 in each of the holes 15.

In view of the above, a plurality of screws must be applied to fix the fan module and the hard disk module of a server in the prior art. However, due to the large volume of the hard disk module, the amount of screws required is large and its processing cost is high. In addition, during the disassembly, it takes a great amount of time and work, and the work efficiency is also adversely affected. Also, the disassembled screws are likely to be lost in the disassembly. Therefore, by locking with screws to fix, the disassembling time and the production cost are not saved, and manufacturing is adversely affected.

Accordingly, it is a highly urgent issue in the industry to provide a stretch type fixing mechanism capable of effectively solving the drawbacks, such as low efficiency, high production cost arising from assembly/disassembly using screws and tools, and losing screws in the disassembling process, in the prior art.

### SUMMARY OF THE INVENTION

In light of the shortcomings of the above prior art, it is an object of the present invention to provide a stretch type fixing mechanism for increasing assembly efficiency.

It is another object of the present invention to provide a stretch type fixing mechanism for lowering production cost.

To achieve the above-mentioned and other objects, the present invention provides a stretch type fixing mechanism in an electronic device. The electronic device at least includes a casing, a first component and a second component. The casing has a base plate for carrying the first component and the second component. The stretch type fixing mechanism includes a first limiting unit having a first wedging section disposed on the casing and a second wedging section corresponding to the first wedging section and disposed on the first component, wherein the second wedging section is wedged in the first wedging section so that the first component is limited to move relatively to the base plate in a first direction; a second limiting unit including a third wedging section disposed on the casing and a fourth wedging section corresponding to the third wedging section and disposed on the second component, wherein the fourth wedging section is wedged in the third wedging section for limiting the second component to move relatively to the base plate in a second direction, and the second direction is opposite to the first direction; and a positioning unit disposed on the first component and having a propping portion, wherein the second component has a blocking portion for propping against the propping portion, thereby positioning the first and the second components at a minimum spacing therebetween, and fixing the first and the second components to the base plate.

According to the afore-mentioned mechanism, the propping portion is a hook, and the blocking portion is a slot corresponding to the propping portion for the propping portion to be wedged therein. The casing further includes two opposite sidewalls, and the first and the third wedging sections are disposed on either the base plate or the two sidewalls.

According to the afore-mentioned mechanism, the first and the third wedging sections are through holes, and the second and the fourth wedging sections are hooks. Alternatively, the second and the fourth wedging sections are the through holes consisting of a large hole and a small hole connected to each other, and the first and the third wedging sections are positioning shafts consisting of a shaft body and an expansion portion extending from one end of the shaft body. Each of the positioning shafts is disposed in the small hole via the large hole, and wedged in the small hole by the shaft body and the expansion portion.

According to the afore-mentioned mechanism, the first component is a heat-dissipating module, and the second component is a hard disk module. Alternatively, the second component is a heat-dissipating module, and the first component is a hard disk module. The electronic device is a server.

In the stretch type fixing mechanism of the present invention, the first and the second component can only move away from each other on the base plate via the first and the second limiting units, and the first and the second components are fixed at a minimum spacing therebetween without further movement by disposing positioning units between the first and the second components. Compared with prior art, the design of the stretch type fixing mechanism in the present invention is capable of fixing the first and the second components to the casing without using any disassembling tools, thereby achieving higher efficiency of assembly. Furthermore, since neither screws nor tools are required in assembly, there is no need of worrying about losing screws either, thereby achieving the object of efficiently lowering production cost.

### BRIEF DESCRIPTION OF DRAWINGS

FIG. 1 is a schematic diagram showing the corresponding positions of the fan module, hard disk module, and casing of a server according to prior art;

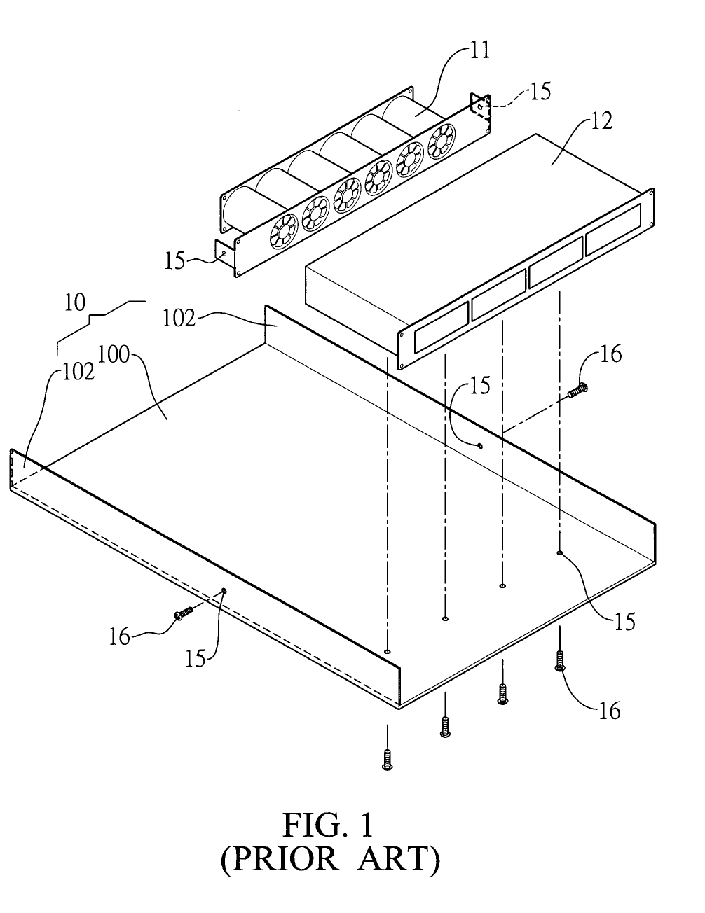

FIG. 2 is a schematic diagram showing the corresponding positions of the first and second components and casing of the stretch type fixing mechanism according to the present invention;

FIG. 3 is a schematic diagram showing the stretch type fixing mechanism of the present invention and an electronic device;

FIGS. 4A and 4B are cross-sectional schematic diagrams showing actions of the positioning unit of the stretch type fixing mechanism according to the present invention; and

FIG. 5 is a schematic diagram showing the stretch type fixing mechanism according to another embodiment of the present invention.

### DETAILED DESCRIPTION OF PREFERRED EMBODIMENTS

The following embodiments are provided to illustrate the disclosure of the present invention, and these and other advantages and effects may be easily conceived by persons skilled in the art from the disclosure of this specification.

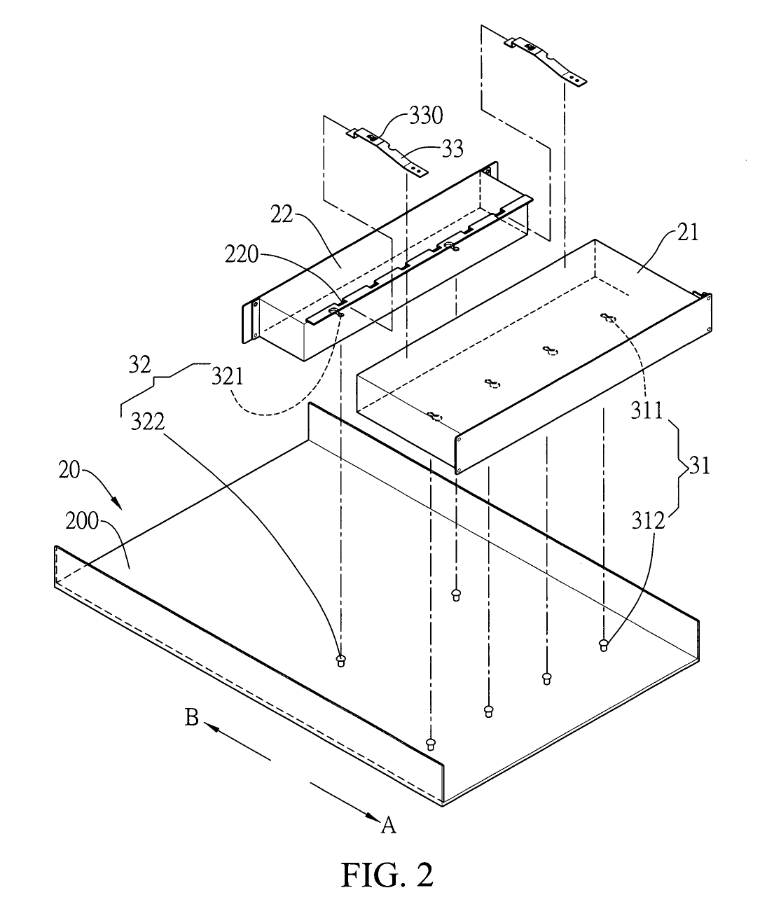

Referring to FIG. 2, FIG. 2 shows the stretch type fixing mechanism of the present invention. FIG. 2 is a schematic view showing the basic structure of the present invention, and the illustrated design is not drawn to show the practical number, proportion, and the shape of elements. It should be noted that the number, the shape and the proportion shown in the design are only an example, and the structure may be more complicated.

As shown in FIG. 2, the stretch type fixing mechanism is disposed on a casing 20, a first component 21 and a second component 22. The casing 20 has a base plate 200 for carrying the first component 21 and the second component 22. The stretch type fixing mechanism includes a first limiting unit 31, a second limiting unit 32 and a plurality of positioning units 33.

The first limiting unit 31 includes a first wedging section 311 disposed on the casing 20 and a second wedging section 312 disposed on the first component 21 and corresponding to the first wedging section 311. The second wedging section 312 is wedged in the first wedging section 311 for limiting the first component 21 to move relatively to the base plate 200 in a first direction A.

The second limiting unit 32 includes a third wedging section 321 disposed on the casing 20 and a fourth wedging section 322 disposed on the second component 22 and corresponding to the third wedging section 312. The fourth wedging section 322 is wedged in the third wedging section 321 for limiting the second component 22 to move relatively to the base plate 200 in a second direction B opposite to the first direction A.

The positioning units 33 are elastic and disposed on the first component 21, and each has a propping portion 330. The second component 22 has blocking portions 220 for propping against the propping portion 330. Thus, the first component 21 and the second component 22 are positioned by the positioning units 33 and do not move in the first direction A and the second direction B, respectively, to fix the first component 21 and the second component 22 to the base plate 200.

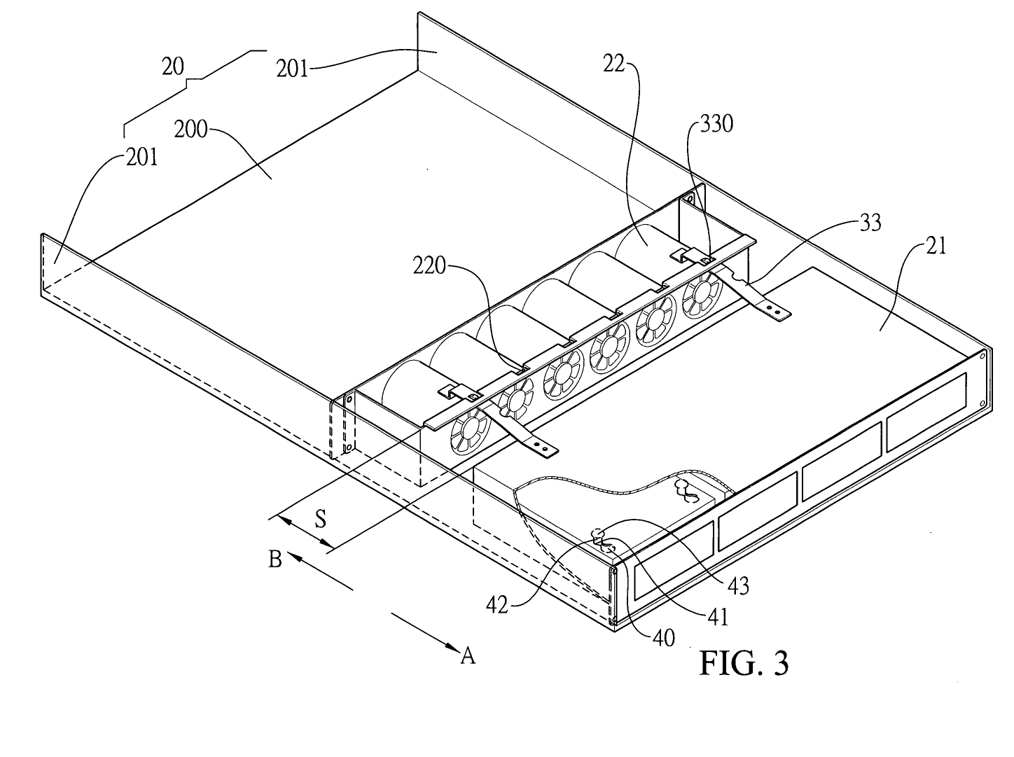

According to the afore-mentioned mechanism and referring also to FIG. 3, FIG. 3 is an embodiment of the stretch type fixing mechanism in an electronic device according to the present invention. The electronic device is, for instance, a server, and at least includes a casing 20, a first component 21 and a second component 22. For example, the first component 21 is a hard disk module, and the second component 22 is a heat-dissipating module. The casing 20 has a base plate 200 and two opposite side walls 201 for carrying the first component 21 and the second component 22. The first wedging section 311 and the third wedging section 321 are disposed on the base plate 200, and the second wedging section 312 is disposed on the first component 21 corresponding to the position of the first wedging section 311. The fourth wedging section 322 is disposed on the second component 22 corresponding to the position of the third wedging section 321. The propping portions 330 are hooks, and the blocking portions 220 are slots corresponding to the hooks for the propping portions 330 to be wedged therein.

In the embodiment, the first component 21 may be a heat-dissipating module, and the second component 22 may be a hard disk module.

The first wedging section 311 and the third wedging section 321 are positioning shafts each consisting of a shaft body 42 and an expansion portion 43 extending from an end of the shaft body 42. The second wedging section 312 and the fourth wedging section 322 are through holes, and each consists of a large hole 40 and a small hole 41 that are connected to each other in a ∞ [symbol] shape. In the present invention, the small holes 40 on the second wedging section 312 face the small holes 40 on the fourth wedging section 322. The shaft bodies 42 and the expansion portions 43 are wedged in the small holes 41 when the positioning shafts enter via the large holes 40 into the small holes 41, so that the first component 21 and the second component 22 can move only in the first direction A and the second direction B opposite to the first direction A, respectively. Then the first component 21 and the second component 22 are positioned at a minimum spacing S therebetween by the positioning units 33 to prevent any further movement, thereby fixing the first component 21 and the second component 22 to the base plate 200.

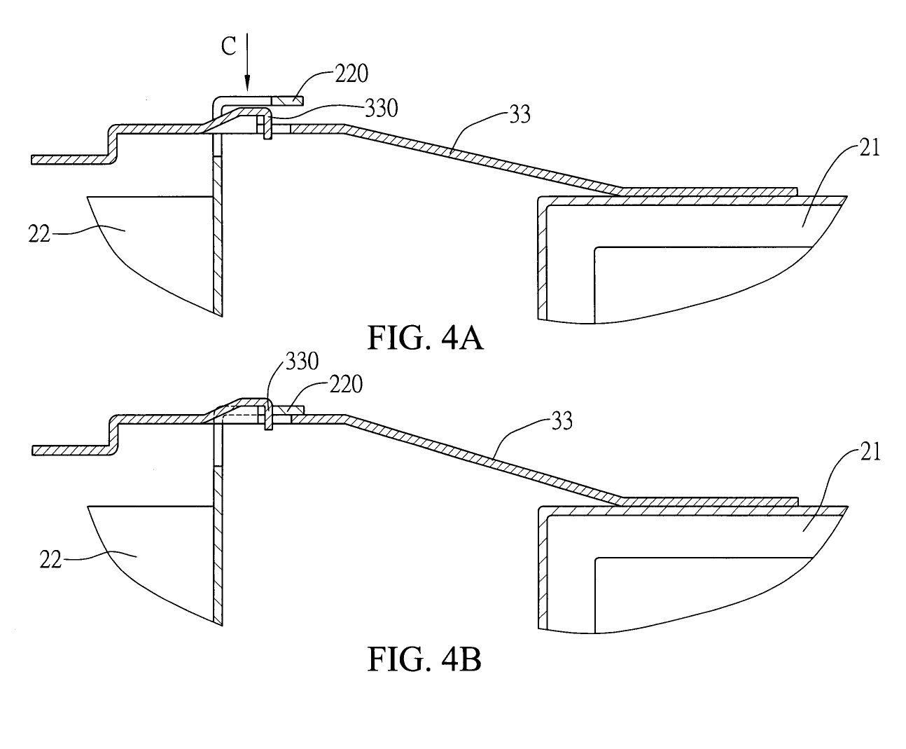

Referring to FIGS. 4A and 4B, FIGS. 4A and 4B are cross-sectional schematic diagrams showing actions the positioning unit 33. During assembly, the positioning unit 33 is elastic, and therefore a force in direction C will make the propping portion 330 of the positioning unit 33 move downwards, and after the second component 22 is disposed on the casing 20 by wedging the fourth wedging section 322 in the third wedging section 321, the force will be removed. Consequently, the propping portion 330 is wedged in the blocking portion 220 by elasticity (the blocking portions 220 have surfaces against the propping portions 330), so that the blocking portion 220 and the propping portion 330 together are capable of preventing the first component 21 and the second component 22 from moving further in the first direction A and the second direction B, respectively. However, specific shapes of the positioning units 33 and the blocking portion 220 are not the major technical features of the present invention, and it should be noted that they may be modified according to any actual applications.

In the stretch type fixing mechanism, the first component 21 and the second component 22 are disposed on the casing 20 by the first limiting unit 31 and the second limiting unit 32, and may only move away from each other relatively to the base plate 200. The positioning unit 33 is disposed between the first component 21 and the second component 22 for fixing the first component 21 and the second component 22 at a minimum distance S therebetween, to prevent from further movement the first component 21 and the second component 22. By this design, compared with prior art, no tools are used for fixing the first component 21 and the second component 22 to the casing 20 in the present invention, and since it takes neither tools nor screws in the assembling/disassembly in the present invention, there is no need of worrying about losing screws.

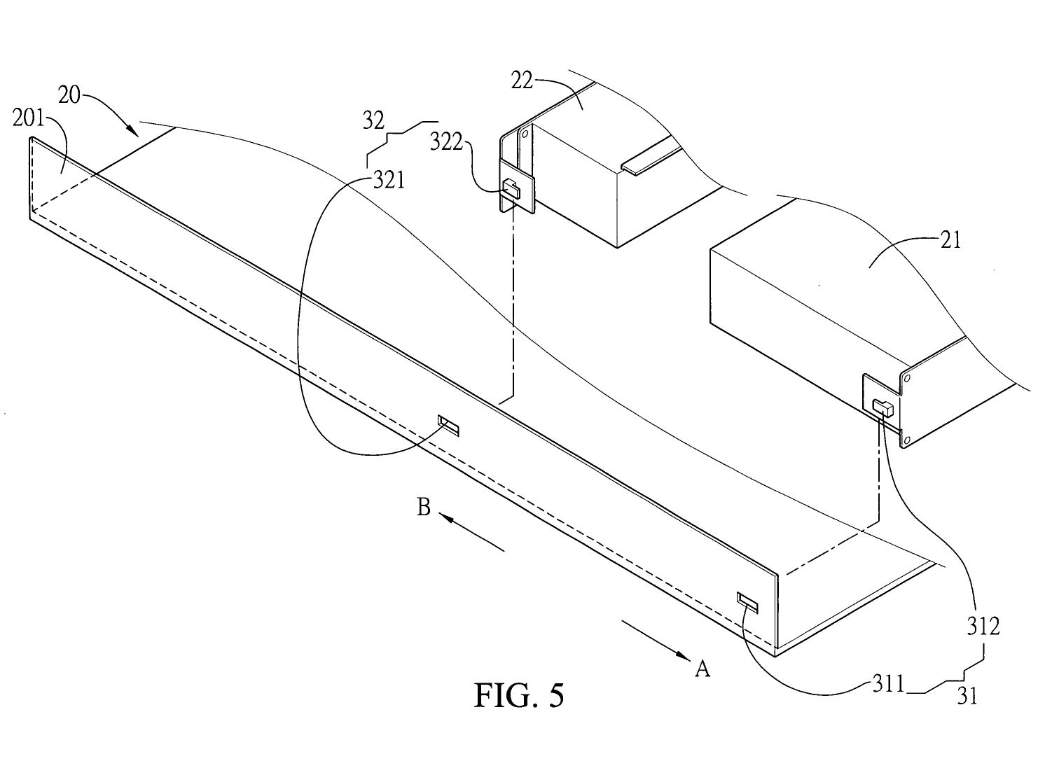

Referring to FIG. 5, FIG. 5 is a schematic diagram showing another embodiment of the stretch type fixing mechanism of the present invention. The only difference between the embodiment and the previous embodiment lies in the wedge structure of first limiting unit 31 and second limiting unit 32 and their disposal on the two sidewalls. Therefore, there is no need of repetitive descriptions of the structures, the positions and the movements of the same designs. The above-mentioned difference is illustrated as follows.

The first wedging section 311 and the third wedging section 321 are through holes disposed on the two sidewalls, and the second wedging section 312 and the fourth wedging section 322 are hooks. The first component 21 is disposed on the casing 20 by wedging the hooks in the through holes, and moved only in the first direction A. The second component 22 is disposed on the casing 20 by wedging the hooks in the through holes, and moved only in the second direction B opposite to the first direction A.

Accordingly, in the stretch type fixing mechanism of the present invention, the first and the second components are moved only away from each other relatively to the base plate via the first and the second limiting units, and the first and the second components are fixed at a minimum spacing therebetween by the positioning units to prevent further movement of the first and second components. Therefore, the stretch type fixing mechanism is capable of fixing the first and the second components to the casing without implementing any tools to achieve assembling efficiency. Furthermore, since it takes neither screws nor tool in the assembling/disassembly in the present invention, there is no need of worrying about losing screws, thereby effectively lowering production cost.

The present invention has been described using exemplary preferred embodiments. However, it is to be understood that the scope of the present invention is not limited to the disclosed arrangements. The scope of the claims, therefore, should be accorded the broadest interpretation, so as to encompass all such modifications and similar arrangements.

What is claimed is:

1. A stretch type fixing mechanism for an electronic device, wherein the electronic device includes a first component, a second component, and a casing having a base plate for carrying the first component and the second component; the stretch type fixing mechanism comprising:
a first limiting unit comprising a first wedging section disposed on the casing and a second wedging section corresponding to the first wedging section and disposed on the first component, wherein the second wedging section is wedged in the first wedging section for limiting the first component to move relatively to the base plate in a first direction;
a second limiting unit comprising a third wedging section disposed on the casing, and a fourth wedging section corresponding to the third wedging section and disposed on the second component, wherein the fourth wedging section is wedged in the third wedging section for limiting the second component to move relatively to the base plate in a second direction opposite to the first direction; and
a positioning unit disposed on the first component and having a propping portion, wherein the second component has a blocking portion against the propping portion, thereby positioning the first component and the second component at a minimum spacing therebetween and fixing the first component and the second component to the base plate.

2. The stretch type fixing mechanism of claim 1, wherein the first and the third wedging sections are through holes, and the second and the fourth wedging sections are hooks.

3. The stretch type fixing mechanism of claim 1, wherein the first and the third wedging sections are positioning shafts, and the second and the fourth wedging sections are through holes.

4. The stretch type fixing mechanism of claim 3, wherein each of the through holes consists of a relatively large hole and a relatively small hole connected to each other, each of the positioning shafts comprises a shaft body and an expansion portion extending from one end of the shaft body, and each of the positioning shafts is disposed in the small hole via the large hole, and wedged in the small hole with the shaft body and the expansion portion.

5. The stretch type fixing mechanism of claim 1, wherein the first and the third wedging sections are disposed on the base plate.

6. The stretch type fixing mechanism of claim 1, wherein the casing further comprises two opposite sidewalls, and the first and the third wedging sections are disposed on the side walls.

7. The stretch type fixing mechanism of claim 1, wherein the propping portion is a hook, and the blocking portions is a slot corresponding to the propping portion.

8. The stretch type fixing mechanism of claim 1, wherein the first component is a heat-dissipating module, and the second component is a hard disk module.

9. The stretch type fixing mechanism of claim 1, wherein the first component is a hard disk module, and the second component is a heat-dissipating module.

10. The stretch type fixing mechanism of claim 1, wherein the electronic device is a server.
